(19) United States
(12) Patent Application Publication
(10) Pub. No.: US 2022/0041901 A1
(43) Pub. Date: Feb. 10, 2022

(54) PHOTOCURABLE ADHESIVE COMPOSITION AND PHOTOCURABLE ADHESIVE TAPE

(71) Applicant: 3M INNOVATIVE PROPERTIES COMPANY, St. Paul, MN (US)

(72) Inventor: Hongmei Wan, Shanghai (CN)

(21) Appl. No.: 17/309,857

(22) PCT Filed: Jan. 24, 2020
(86) PCT No.: PCT/IB2020/050570

§ 371 Date: Jun. 24, 2021

(30) Foreign Application Priority Data
Jan. 28, 2019 (CN) 201910083198.7

(51) Int. Cl. C09J 7/38; C09J 7/10; C09J 7/40; C09J 11/06; C09J 11/04

(52) U.S. Cl. CPC C09J 7/385; C09J 7/10; C09J 7/405; C09J 11/06; C09J 2400/28; C09J 2301/416; C09J 2301/408; C09J 2433/00; C09J 11/04

(57) ABSTRACT

The present invention provides a photocurable adhesive composition. The photocurable adhesive composition comprises, based on the total solid content thereof, 10 to 40 wt % of a thermoplastic polymer containing carboxylic groups and epoxy groups, 20 to 50 wt % of an epoxy component, 1 to 10 wt % of a hydroxy-containing compound, and 0.1 to 5 wt % of a photoinitiator. The present invention further provides a photocurable adhesive tape comprising the photocurable adhesive composition. The photocurable adhesive composition and the photocurable adhesive tape prepared according to technical solutions of the present invention have excellent adhesiveness to phosphorus-containing nickel-plated substrates.

### TECHNICAL FIELD

The present invention relates to the technical field of pressure sensitive adhesives, and specifically, to a photocurable adhesive composition and a photocurable adhesive tape.

### BACKGROUND

Facilitating heat dissipation helps electronic appliances stay in good working order. In order do so, it requires radiators to be secured by means of bonding solutions to heat-generating members of the electronic appliances, such as chips. Common heat-generating electronic members include plastic chips, metallic copper chips, aluminum panels, and copper panels. At present, a majority of electronic appliances employ corrosion-resistant nickel coated substrates. Bond formation on nickel-plated electronic devices, however, is often more challenging than bond formation on devices with other types of substrates.

In the typical application scenarios and markets as described above, bonding methods involving high-temperature heating are usually not applicable due to the electronic elements' and devices' limited heat resistance or member size. Common bonding methods employed thus include, for example, a two-component curable thermally conductive adhesive or a moisture curable adhesive containing a curing agent. These bonding methods in these adhesive solutions often involve a complex process. First of all, the fluid adhesive needs to be smeared or extruded onto the surface of the element or device such as a chip. Using tools of different sizes, the adhesive is evenly and homogeneously spread on the surfaces of different sizes on the element or device. Sometimes grinding is further required on the surface, so as to eliminate bubbles or allow the paste adhesive containing a filler to fully infiltrate the surface to be bonded. The adhesive, which contains a curing agent, requires both online mixing and waiting time for the curing agent to take effect. After the adhesive is uniformly smeared on the surface of the electronic element or device, the electronic element or device is attached to another element, such as a radiator device. A complete circuit board often contains one or more bonded components, and the adhesive solution requires a certain reaction time. A common adhesive does not have enough initial bonding force, and thus additional waiting is required before the bonded circuit board is ready for the next process. It is thus apparent that the existing bonding methods employing fluid adhesives involve complex processes and are low in production efficiency. In addition, curing agents of some two-component curable adhesives are volatile liquid reagents, which can cause environmental problems in the workstation.

Therefore, those skilled in the art are urgently expected to develop an adhesive product that has good adhesion and thermal conductivity for nickel-plated substrates. The adhesive product is furthermore expected to effectively overcome the disadvantages in the existing common adhesive solutions, namely complex processes, low production efficiency, and environmental pollution.

### SUMMARY

As an attempt to address the technical problems described above, the present invention aims to provide a photocurable adhesive composition and photocurable adhesive tape having excellent adhesion and good thermal conductivity on nickel-plated substrates. In addition, the UV-light reactive pressure sensitive adhesive composition provided by the present invention and the pressure sensitive adhesive reactive adhesive tape prepared therefrom can effectively overcome the disadvantages in the existing bonding methods involving adhesives, namely complex processes, low production efficiency, and environmental pollution.

The inventors have conducted intensive and detailed research to obtain the present invention.

According to one aspect of the present invention, a photocurable adhesive composition is provided. The photocurable adhesive composition comprises, based on the total content of solids thereof, the following:

10 to 40 wt % of a thermoplastic polymer containing carboxylic groups and epoxy groups;

20 to 50 wt % of an epoxy component;

1 to 10 wt % of a hydroxy-containing compound; and

0.1 to 5 wt % of a photoinitiator.

According to some preferred embodiments of the present invention, the thermoplastic polymer comprises, based on the total solid content thereof, 0.01 to 10 wt % of repeating units containing carboxylic groups.

According to some preferred embodiments of the present invention, the thermoplastic polymer comprises, based on the total solid content thereof, 0.01 to 5 wt % of repeating units containing epoxy groups.

According to some preferred embodiments of the present invention, the thermoplastic polymer is a thermoplastic acrylic polymer.

According to some preferred embodiments of the present invention, the thermoplastic polymer is a copolymer comprising repeating units derived from acrylic acid and repeating units derived from glycidyl (meth)acrylate.

According to some preferred embodiments of the present invention, the weight average molecular weight of the thermoplastic polymer is in a range from 400,000 to 1,200,000.

According to some preferred embodiments of the present invention, the epoxy component comprises one or a plurality of epoxy resins and/or epoxy monomers.

According to some preferred embodiments of the present invention, the weight average molecular weight of the epoxy component is in a range from 100 to 5,000.

According to some preferred embodiments of the present invention, the epoxy equivalent weight of the epoxy component is in the range from 80 g/eq to 1,000 g/eq.

According to some preferred embodiments of the present invention, the hydroxy-containing compound has a hydroxyl functionality of at least 1.

According to some preferred embodiments of the present invention, the hydroxy-containing compound is polyol.

According to some preferred embodiments of the present invention, the photoinitiator is one or a plurality of photoinitiators selected from the group consisting of photoinitiators containing α-aminoketo groups, photoinitiators containing benzylketal groups, photoinitiators containing benzophenone groups, aryl iodonium salt photoinitiators, aryl sulfonium salt photoinitiators, alkyl sulfonium salt photoinitiators, iron aromatic salt photoinitiators, and sulfonylureaoxy free radical ketone photoinitiators.

According to some preferred embodiments of the present invention, the photocurable adhesive composition further comprises a thermally conductive filler.

According to some preferred embodiments of the present invention, the photocurable adhesive composition comprises, based on the total solid content thereof, 20 to 60 wt % of the thermally conductive filler.

According to some preferred embodiments of the present invention, the thermally conductive filler is one or a plurality of materials selected from the group consisting of ceramic, metal oxide, metal nitride, metal hydroxide, BN, SiC, AlN, Al₂O₃, and Si₃N₄.

According to some preferred embodiments of the present invention, the thermally conductive material has a thermal conductivity of 100 W/m·k or more.

According to some preferred embodiments of the present invention, the photocurable adhesive composition further comprises a surfactant.

According to some preferred embodiments of the present invention, the photocurable adhesive composition comprises, based on the total solid content thereof, less than or equal to 5 wt % of the surfactant.

According to some preferred embodiments of the present invention, the surfactant is a silane surfactant.

According to another aspect of the present invention, a photocurable adhesive tape is provided. The photocurable adhesive tape comprises the following:

a first release layer;

a photocurable adhesive layer; and

a second release layer,

wherein the photocurable adhesive layer is provided between the first release layer and the second release layer and comprises the photocurable adhesive composition as described above.

Compared with the prior art, the present invention has the following advantages: the photocurable adhesive composition and the photocurable adhesive tape provide good adhesion on alkaline surfaces of phosphorus-containing nickel-plated substrates and can be widely applied to bonding substrates of various electronics and appliances. The invention provides an adhesive product with improved receptivity on surfaces of various substrates. The applicable surfaces thereof is expanded from non-alkaline surfaces, such as plastic substrates and neutral metals, to neutral, acidic, and alkaline surfaces. In addition, the UV-light reactive pressure sensitive adhesive composition provided by the present invention and the pressure sensitive adhesive reactive adhesive tape prepared therefrom can effectively overcome the disadvantages in the existing bonding methods involving adhesives, namely complex processes, low production efficiency, and environmental pollution.

### DETAILED DESCRIPTION

The present invention will be further described in detail below in conjunction with the embodiments. It will be appreciated that other embodiments are considered, and can be practiced without departing from the scope and spirit of the present invention. Therefore, the following detailed description is non-limiting.

All figures for denoting characteristic dimensions, quantities and physiochemical properties used in this description and claims are to be understood as modified by a term “approximately” in all situations, unless indicated otherwise. Therefore, unless stated conversely, parameters in numerical values listed in the above specification and the claims are all approximate values. Those skilled in the art are capable of seeking and obtaining desired properties by taking advantage of the content of the teachings disclosed herein, as well as changing these approximate values appropriately. The use of a numerical range represented by end points includes all figures within the range and any range within the range, for example, 1 to 5 includes 1, 1.1, 1.3, 1.5, 2, 2.75, 3, 3.80, 4, 5, and the like.

The inventors found that in practical applications, not all UV-light reactive pressure sensitive adhesives are equally effective when applied to bond various heat-dissipating electronic devices. In real life applications of UV-light reactive pressure sensitive adhesives in electronics and electric appliances, it is often found that the adhesion of conventional cationic pressure sensitive adhesives to substrates having nickel coatings decreases significantly with time or even fails. The inventors of the present application have conducted intensive and systematic research on this issue, and found that the substrate on the surface of the nickel-plated electron device has a significant amount of phosphorus (even up to 5.4 wt % of the total weight of the nickel coating of the nickel substrate). Without being bound by theory, the inventors of the present application speculate that the significant amount of phosphorus on the surface of the nickel-plated substrate comes from the technical process of nickel plating. The presence of the significant amount of phosphorus causes the surface to be alkaline, and an “alkaline” bonding environment is formed on the substrate. This results in a decrease or failure in bonding strength between the surface of the nickel-plated substrate and the common and general cationic UV curable composition which is used to prepare UV-light reactive pressure sensitive adhesives. Based on the above considerations, a photocurable adhesive composition is provided in the technical solutions of the present invention. The invention is used to solve the problems found when a photoinitiated pressure sensitive adhesive is bonded to a nickel-plated chip with an alkaline substrate, and can effectively overcome the obstacles when attempting to cure a cationic UV curable composition system on a high-phosphorus-content substrate. The photocurable adhesive composition comprises a thermoplastic polymer containing carboxylic groups and epoxy groups. The thermoplastic polymer is preferably a thermoplastic acrylic polymer. The carboxylic groups contained in the thermoplastic acrylic polymer can significantly improve the adhesion of a pressure sensitive adhesive to a substrate with a nickel coating. In addition, the inventors of the present application surprisingly found that the technical effect of improving the adhesion of the pressure sensitive adhesive to the substrate with a nickel coating cannot be achieved when only a corresponding amount of organic acid is added to the adhesive composition without adding a thermoplastic polymer containing carboxylic groups. In addition, the inventors of the present application found that when the thermoplastic polymer containing carboxylic groups further contains epoxy groups, the compatibility between the thermoplastic polymer and the epoxy component is significantly improved, and the adhesion of the pressure sensitive adhesive to the nickel-plated substrate is also improved. The photocurable adhesive composition according to the present invention can be used in bonding processes of a wide variety of elements or devices, such as electronic circuit boards and chips having common zinc-plated substrates or high-phosphorus-content hard-to-bond substrate surfaces. The invention is applicable to a wide range of markets and fields, such as power supplies, base station equipment, automobiles, electronic elements or devices, semiconductors, and hand-held electronic products.

Specifically, the present invention provides a photocurable adhesive composition. The photocurable adhesive composition comprises, based on the total content of solids thereof, the following:

10 to 40 wt % of a thermoplastic polymer containing carboxylic groups and epoxy groups;

20 to 50 wt % of an epoxy component;

1 to 10 wt % of a hydroxy-containing compound; and

0.1 to 5 wt % of a photoinitiator.

Various materials can be used in the photocurable adhesive composition of the present invention. A description of the materials suitable for the present invention is given below.

Unless otherwise stated, all parts, percentages, concentrations and the like used herein are based on weight.

A. Thermoplastic Polymer Containing Carboxylic Groups and Epoxy Groups

The photocurable adhesive composition of the present invention comprises a thermoplastic polymer containing carboxylic groups and epoxy groups. The thermoplastic polymer is used to aid the coating process and formation of an adhesive film, and the carboxylic groups contained in the thermoplastic polymer are used for improving the adhesion of the pressure sensitive adhesive to the nickel-plated substrate. In particular, the carboxylic groups in the thermoplastic polymer can strengthen the acidic environment for the cationic UV-light reactive composition. An acidic environment can effectively mitigate the effects produced by the electron-feeding effect of the composition due to the alkaline zinc-plated substrate and/or phosphorus coating-containing substrate, which can cause inhibition or deceleration of photoinitiated reactions. It is found through experiments that simply adding and mixing an ionic acid does not produce obvious results.

The thermoplastic polymer containing carboxylic groups and epoxy groups is compatible with the epoxy component used in the composition of the present invention. The thermoplastic polymer used in the present invention has a Mooney viscosity at 100° C. of 10 to 100, and preferably 10 to 70, to ensure good performance and proper molecular weight required in the coating process as well as successful formation of an adhesive film. The thermoplastic polymer has a weight average molecular weight ranging from 400,000 to 1,200,000, and preferably from 500,000 to 900,000. If the molecular weight of the thermoplastic polymer is too low, the polymer does not have sufficient cohesion to form a film coat. On the other hand, if the molecular weight of the thermoplastic polymer is too high, it is not easy to dissolve the polymer in the solvent for the coating process.

There is no particular restriction on the thermoplastic polymer that can be used. A thermoplastic polymer resin commonly used as an adhesive in conventional techniques can be used, provided that the thermoplastic polymer contains both carboxylic groups and epoxy groups at the same time. Examples of thermoplastic polymers suitable for the present invention include, but are not limited to, ethylene-vinyl acetate copolymers and acrylic polymer resins containing both carboxylic groups and epoxy groups at the same time.

The thermoplastic polymer comprises, based on the total solid content thereof, 0.01 to 10 wt % and preferably 1 to 5 wt % of repeating units containing carboxylic groups. The “repeating units containing carboxylic groups” according to the present invention refer to repeating units derived from the monomer providing carboxylic groups found in the thermoplastic polymer prepared by the copolymerization method. Preferably, the thermoplastic polymer is a thermoplastic acrylic polymer. There is no particular restriction on the acrylic polymer that can be used. Any acrylic polymer resin used as an adhesive in conventional techniques can be used, provided that the acrylic polymer resin comprises both carboxylic groups and epoxy groups at the same time in amounts as mentioned in the present application. The basic polymer used in the adhesive composition may be obtained, before being used in the present invention, by polymerization or by a UV polymerization method during the process of mixing with other materials.

Preferred examples of acrylic polymer resins containing carboxylic groups and epoxy groups include polymers formed by copolymerization of C1-12 alkyl (meth)acrylate monomers, polar monomers containing carboxylic groups, and monomers containing epoxy groups.

Examples of C1-12 alkyl (meth)acrylate monomers include, but are not limited to, butyl (meth)acrylate, hexyl (meth)acrylate, n-octyl (meth)acrylate, i-octyl (meth)acrylate, 2-ethylhexyl (meth)acrylate or i-nonyl (meth)acrylate, etc.

Examples of polar monomers containing carboxylic groups include monomers containing carboxylic groups, such as (meth)acrylic acid, maleic acid, and fumaric acid, etc. These polar monomers can be used to provide carboxylic groups to thermoplastic polymers, and provide cohesion and improve adhesion strength for the adhesive.

Examples of monomers containing epoxy groups include glycidyl (meth)acrylate of C1-12 alkyl, such as glycidyl acrylate, and glycidyl methacrylate, etc.

Preferably, the thermoplastic polymer has an intrinsic viscosity (IV) of greater than 0.8, preferably greater than 1.0, and a glass transition temperature of approximately −30° C. or lower.

The following should be noted: the inventors of the present application found that when the thermoplastic polymer containing carboxylic groups further contains epoxy groups, the adhesion of the pressure sensitive adhesive to the nickel-plated substrate is significantly improved. Intending not to be bound by theory, it is speculated that the mechanism of how thermoplastic polymer containing both carboxylic groups and epoxy groups provide a significantly improved adhesion of the adhesive to the nickel-plated substrate is as follows: when the thermoplastic polymer contains epoxy groups, the epoxy groups in the thermoplastic polymer can effectively enhance the compatibility of the thermoplastic polymer containing carboxylic groups with the epoxy component, where a portion of the epoxy groups in the thermoplastic polymer can also participate in the UV-initiated curing reaction to form a network structure and play a synergistic viscosifying role with the carboxylic groups. In contrast, when the thermoplastic polymer contains carboxylic groups instead of epoxy groups, the compatibility of the thermoplastic polymer with other components in the photocurable adhesive composition is poor, and the photocurable adhesive composition with good adhesion performance cannot be obtained.

The thermoplastic polymer comprises, based on the total solid content thereof, 0.01 to 5 wt % and preferably 0.1 to 3 wt % of repeating units containing carboxylic groups. “Repeating units containing epoxy groups” according to the present invention refers to repeating units derived from monomers providing epoxy groups found in thermoplastic polymers prepared by the copolymerization method. Preferably, the thermoplastic polymer is a copolymer comprising repeating units derived from acrylic acid and repeating units derived from glycidyl (meth)acrylate. Preferably, the thermoplastic polymer is a copolymer comprising repeating unit derived from acrylic acid (AA), repeating units derived from glycidyl methacrylate (GMA), repeating units derived from methyl acrylate (MA), and repeating units derived from butyl acrylate (BA). The above copolymer comprising repeating units derived from acrylic acid and repeating units derived from glycidyl (meth)acrylate may be prepared by a synthetic method conventional in the art for preparing block polymers.

According to technical solutions of the present invention, the photocurable adhesive composition comprises, based on the total solid content thereof, 10 to 40 wt % of a thermoplastic polymer containing carboxylic groups and epoxy groups.

Specific examples of the thermoplastic acrylic polymer suitable for the present invention include the following: thermoplastic acrylic polymers with a brand name of CSA910 produced by 3M Innovation Co., Ltd. (where the weight ratio of methyl acrylate (MA), butyl acrylate (BA), acrylic acid (AA) and glycidyl methacrylate (GMA) is MA/BA/AA/GMA=48.5/50/1/0.5); thermoplastic acrylic polymers with a brand name of CSA930 produced by 3M Innovation Co., Ltd. (where the weight ratio of methyl acrylate (MA), butyl acrylate (BA), acrylic acid (AA) and glycidyl methacrylate (GMA) is MA/BA/AA/GMA=68.5/27/3/0.5); and thermoplastic acrylic polymers with a brand name of CSA960-1 produced by 3M Innovation Co., Ltd. (where the weight ratio of methyl acrylate (MA), butyl acrylate (BA), acrylic acid (AA) and methyl acrylate (GMA) is GMA is MA/BA/AA/GMA=68.75/24/6/0.25).

B. Epoxy Component

The epoxy component according to the present invention comprises one or a plurality of epoxy resins and/or epoxy monomers, which are used to form a main structure of the adhesive.

The epoxy component used in the present invention may be any organic compound having at least one cycloxane ring polymerizable by ring opening reaction. This material is also known as epoxide, including monomer epoxides and polymeric epoxides, and may be, for example, aliphatic, alicyclic, heterocyclic, cycloaliphatic or aromatic epoxides, and may further be a combination thereof. It is preferable to use a liquid epoxy resin with a low Tg to allow the adhesive composition to have good viscosity and adhesiveness at room temperature. In other words, an epoxy resin with a Tg lower than room temperature is preferably selected in the present invention. Polymer epoxides include, but are not limited to, linear polymers having a terminal epoxy group (e.g., diglycidyl ether of polyoxyethylene glycol), polymers having backbone cycloxane units (e.g., polybutadiene polyepoxide), and polymers having side chain epoxy groups (e.g., glycidyl methacrylate polymers or copolymers). The epoxy resin may have a weight average molecular weight of approximately 100 to 5,000, preferably approximately 300 to 4,000, and most preferably approximately 500 to 3,000.

The epoxy component used in the present invention ideally comprises one or a plurality of epoxy resins with an epoxy equivalent of 80 g/eq to 1,000 g/eq approximately, more ideally 100 g/eq to 800 g/eq approximately, and more ideally 100 g/eq to 400 g/eq approximately. In one embodiment, the epoxy component in the present invention comprises two or more epoxy resins having different epoxy equivalents.

Epoxy resin suitable for the present invention includes, but is not limited to, aromatic epoxides, alicyclic epoxides, and alicyclic epoxides.

Aromatic epoxides include glycidyl ethers of polyphenols, such as hydroquinone, resorcinol, bisphenol A, bisphenol F, 4,4′-dihydroxybiphenyl, phenolic varnishes, and tetrabromobisphenol A.

Alicyclic epoxides include polyglycidyl ethers of polyols having at least one alicyclic ring and compounds containing cyclohexene oxides or cyclopentene oxides obtained by epoxidation of cyclohexene or cyclopentene ring compounds with an oxidant.

A specific example of an epoxy component is hydrogenated bisphenol A diglycidyl ether, such as (3,4-epoxycyclohexyl)methyl 3,4-epoxy-cyclohexylcarboxylate, 3,4-epoxy-1-methylcyclohexyl 3,4-epoxy-1-methylcyclohexane carboxylate, (6-methyl-3,4-epoxycyclohexyl)methyl 6-methyl-3,4-epoxy-cyclohexane carboxylate, (3,4-epoxy-3-methylcyclohexyl)methyl 3,4-epoxy-3-methylcyclohexane carboxylate, (3,4-epoxy-5-methylcyclohexyl)methyl 3,4-epoxy-5-methylcyclohexane carboxylate, bis(3,4-epoxycyclohexylmethyl)adipate, methylene bis(3,4-epoxycyclohexane), 2,2-bis(3,4-epoxycyclohexyl)propane, dicyclopentadiene diepoxides, ethylene bis(3,4-epoxycyclohexane carboxylate), dioctylepoxyhexahydrophthalate and di-2-ethylhexyl epoxyhexahydrophthalate.

Aliphatic epoxides include the following: polyglycidyl ethers of aliphatic polyols or allyl oxide adducts thereof, polyglycidyl ester of aliphatic long-chain polyhydric acids; homopolymers synthesized by vinyl polymerization of glycidyl acrylate or glycidyl methacrylate; and copolymers synthesized by vinyl polymerization of glycidyl acrylate or glycidyl methacrylate and other vinyl monomers. Typical examples include glycidyl ethers of polyols, such as the following: 1,4-butanediol diglycidyl ether, 1,6-5-glycol diglycidyl ether, glycerol triglycidyl ether, trimethylolpropane triglycidyl ether, sorbitol tetraglycidyl ether, dipentaerythritol hexaglycidyl ether, polyethylene glycol diglycidyl ether, and polypropylene glycol diglycidyl ether; polyether polyol polyglycidyl ether obtained by adding one or a plurality of oxyalkanes to aliphatic polyols such as propylene glycol, trimethylolpropane and glycerin; and diglycidyl ester of aliphatic long-chain dibasic acids. Aliphatic epoxides also include monoglycidyl ethers of aliphatic higher alcohols, monoglycidyl ethers of phenol, cresol or butylphenol, or polyether alcohols obtained by addition of cycloxane; glycidyl esters of higher fatty acids, epoxidized soybean oil, octyl epoxy stearate, butyl epoxy stearate, and epoxidized polybutadiene.

The epoxy component of the present invention comprises one or a plurality of epoxy resins selected from the above-mentioned polyepoxides.

Many commercially available epoxy resins can be used in the present invention. Easily available epoxides include, but are not limited to, bisphenolpropane epoxy resin 618/0164E, 163 available from Blue Star Materials Company (China), bisphenolpropane epoxy resin YD128 available from Baling Petrochemical Company (China), 850 available from DIC Company (China), and novolac epoxy resins F44, F44, F48 and F51 available from Blue Star Materials Company (China). The epoxy resin component for the present invention may comprise one or a plurality of epoxy resins, the amounts of which may vary according to the required properties of the photocurable adhesive composition. Preferably, based on the total solid content of the photocurable adhesive composition, the content of the epoxy component is 20 to 50 wt %, and preferably 30 to 40 wt %.

In one embodiment, YD128, which is commercially available from Kukdo Chemical (Kunshan) Co., Ltd. (China), can be used. YD128 has an epoxy equivalent of approximately 187 and is a liquid at room temperature and atmospheric pressure.

C. Hydroxy-Containing Compound

The photocurable adhesive composition according to the present invention may comprise 1 to 10 wt % of hydroxyl functional components, such as polyols. The hydroxyl functional component can promote the effect of the photoinitiator. Additionally, when the hydroxy-containing compound is a polyol, it can promote the continuous delivery after ring opening of the epoxy component.

The hydroxy-containing compound has a hydroxyl functionality of at least 1. Preferably, the hydroxy-containing compound is a polyol. Examples of commercially available polyols include DL-400, DL-1000D, DL-2000D, EP-330N, POP-36, POP-28 and the like available from Blue Star Company of Shandong (China), and all of these polyols are also available from Xiangkang Chemical Company of Shanghai (China).

In one embodiment, Voranol 2070 polyol commercially available from Dow Chemical Company, US is used. Voranol 2070 polyol is a medium reactive polyether triol with a molecular weight of 700.

D. Photoinitiator

The photocurable adhesive composition of the present invention further comprises an effective amount of a photoinitiator component as a curing agent for crosslinking the pressure sensitive adhesive. Photoinitiators for the present invention are activated ideally by a photochemical method, for example, photochemical radiation (i.e., radiation with a wavelength within a UV or visible portion of an electromagnetic spectrum), or electron beam activation. Compared with heating initiation, photoinitiation is more effective when energy consumption is considered.

The photoinitiator is present in an amount of 0.1 to 5 wt % approximately and preferably 0.2 to 3 wt % based on the total solid content of the photocurable adhesive composition. The amount of the photoinitiator used herein may depend on the light source and the exposure level.

The photoinitiator used in the present invention may be any suitable photoinitiator, such as free radical photoinitiators or cationic photoinitiators. Specifically, different photoinitiators may be combinedly used; for example, a free radical photoinitiator may be used together with a cationic photoinitiator. Examples of the photoinitiator include the following: photoinitiators containing α-aminoketo groups, photoinitiators containing benzylketal groups, photoinitiators containing benzophenone groups, aryl iodonium salt photoinitiators, aryl sulfonium salt photoinitiators, alkyl sulfonium salt photoinitiators, iron aromatic salt photoinitiators, sulfonylureaoxy free radical ketone photoinitiators and the like, or a mixture thereof. The use of onium salt photoinitiators, such as iodonium and sulfonium complex salts, is preferred. The photoinitiator may have a melting point higher than 70° C. Considering that the product of the invention is endowed with higher temperature resistance, it is preferred that a photoinitiator with a higher melting point is used. Different photoinitiators may be added into the composition separately, or added simultaneously as a mixture.

Suitable commercially available photoinitiators include, but are not limited to, TPO (2,4,6-trimethylbenzoyldiphenylphosphine oxide) available from Shanghai H&C Fine Chemistry Co., Ltd.; 1107 (2-methyl-1-(4-methylthio))phenyl-2-morpholinopropan-1-one) available from Guangzhou Toupu Chemical Co., Ltd.; 184 (1-hydroxy-cyclohexyl-phenyl-one) available from Shanghai H&C Fine Chemistry Co., Ltd.; and 1105 (2-isopropylthioxanthone) and DETX (2,4-diethylthioxanthone) available from Shanghai H&C Fine Chemistry Co., Ltd. In at least one embodiment of the present invention, a cationic photoinitiator 1190 available from IgM Resins Company (China) is used. The cationic photoinitiator 1190 is a mixture of triarylsulfonium hexafluorophosphate salts, and is comprised of bis(4-(diphenylsulfonyl)phenyl)sulfide bis(hexafluorophosphate) and diphenyl(4-phenylthio)phenyl hexafluorophosphate. The cationic photoinitiator 1190 is for the cationic curing of epoxy resin, oxyheterocyclobutane, and vinyl ether.

E. Thermally Conductive Filler

The photocurable adhesive composition of the present invention may have a thermally conductive material, such as a thermally conductive filler, added therein to form a thermally conductive adhesive composition. In addition to thermal conductivity, electrical insulation is a preferred property when selecting the thermally conductive filler, so as to obtain high electrical insulation performance. Suitable materials include, but are not limited to, ceramic, metal oxide, metal nitride, metal hydroxide, BN, SiC, AlN, Al₂O₃ and Si₃N₄. The thermally conductive material preferably has a thermal conductivity of 100 W/m·k or more. These materials may be used separately, or as an alternative, used in a combination of two or more. Based on the total solid content of the thermally conductive photocurable adhesive composition, the amount of the thermally conductive filler ranges from 20 to 60 wt % approximately and preferably from 25 to 45 wt % approximately. With consideration of the balance between the required thermal conductivity and the appropriate cohesion of the adhesive composition, thermally conductive fillers with different particle sizes can be used in combination. The average particle size of a preferred thermally conductive filler is in a range from 0.01 to 50 μm approximately, depending on the layer thickness. The photocurable adhesive composition of the present invention may be made into a product with a thickness of 10 to 500 μm, and preferably 30 to 300 μm, and the pressure sensitive adhesives can be used in adhesion applications.

In order to improve the cohesion of the layer, thermally conductive fillers which have been surface-treated with silane, titanate, and the like may be used. Examples of suitable thermally conductive fillers include, but are not limited to, boron nitride (BN) and aluminum trihydrate (ATH). In some embodiments, BN fillers of different particle diameters are preferred. Examples of commercially available fillers suitable for the present invention include, but are not limited to, boron nitride fillers CF200, CF100, CF300 and CF500, commercially available from China Yingkou Pengda Chemical Materials Company or China Momentive Company.

For example, the boron nitride filler CF500 commercially available from China Momentive Company with an average particle diameter of 12 μm and a surface area of 7 m2/g, may be employed. In another embodiment, the thermally conductive material comprises a metal hydrate, such as aluminum hydroxide (ATH) from Ruifeng Materials Company (Suzhou, China), which has an average particle size of 5-10 μm and a D10/D90 of 1/15 μM.

In some embodiments of the present invention, a preferred material is aluminum hydroxide.

F. Surfactant

The photocurable adhesive composition of the present invention comprises a surfactant to improve the compatibility of various components. The photocurable adhesive composition comprises, based on the total solid content thereof, less than or equal to 5 wt % of the surfactant. The surfactant is preferably a silane surfactant.

An example of silane surfactants that can be used in the present invention includes KH560 (γ-(2,3-epoxypropoxy)propyltrimethoxysilane) produced by Dow Corning or Momentive Company.

G. Other Ingredients

The photocurable adhesive composition of the present invention may also comprise other additives, such as tackifiers, antioxidants, coupling agents, thickening agents, auxiliary flame retardants, defoamers, pigments, and surface modifier. The amount of other additives is, based on the total solid content of the photocurable adhesive composition, 0 to 5 wt % approximately, so that the photocurable adhesive composition is provided with preferred physical properties according to the use thereof.

In order to provide high adhesion strength, a tackifier resin is preferably used in some embodiments of the adhesive composition of the present invention. Preferred tackifiers include one or a plurality of resins selected from the group consisting of terpene-phenolic resins, rosin ester resins, and the like. The preferred tackifiers are tackifiers with different softening points, which can provide good viscosity and adhesiveness to the photocurable adhesive composition. Examples of suitable tackifiers include, but are not limited to, TP2040 available from US Arizona Chemical Company, GAAT available from US Arizona Chemical Company, and GA90A available from China Wu Zhou Sun Shine. Examples of the coupling agent include silane coupling agents and organic titanate coupling agents. For example, A171 from US Dow Corning is suitable for the present invention.

The photocurable adhesive composition according to the present invention may further comprise a solvent. The solvent amount may vary within a wide range. In some embodiments, based on the total weight of the photocurable adhesive composition, the solvent may be present in an amount of at most 60 wt % approximately, or at most 50 wt % approximately, or at most 40 wt % approximately. In some embodiments, based on the total weight of the composition, the solvent may be present in an amount of greater than 10 wt % approximately, or greater than 20 wt % approximately, or greater than 30 wt % approximately, or greater than 40 wt % approximately. Examples of the solvent suitable for the present invention include, but are not limited to, ethyl acetate, toluene, xylene, alcohol such as methanol, ethanol or isopropanol, and acetone.

There is no particular restriction on the method that can be used for preparing the photocurable adhesive composition according to the present invention. The composition can be prepared by mixing specific amounts of components through a conventional mixing method in the art.

According to another aspect of the present invention, a photocurable adhesive tape is provided. The photocurable adhesive tape includes the following:

a first release layer;

a photocurable adhesive layer; and

a second release layer, wherein

the photocurable adhesive layer is provided between the first release layer and the second release layer and comprises the photocurable adhesive composition as described above.

There is no particular restriction on the materials that can be used for forming the first release layer and the second release layer. Release materials commonly used in the art, including release paper and release film layers, can be used.

The photocurable adhesive tape according to the present invention can be prepared according to any method conventionally used for preparing pressure sensitive adhesive tapes and the like. For example, the photocurable adhesive tape according to the present invention can be prepared by applying the photocurable adhesive composition onto the first release layer to form a photocurable adhesive layer, and then covering the second release layer on the photocurable adhesive layer.

The present invention will be described below in further detail in combination with embodiments. It needs to point out that, these descriptions and embodiments are all intended to make the invention easy to understand, rather than to limit the invention. The protection scope of the present invention is subject to the appended claims.

### EMBODIMENTS

In the present invention, unless otherwise pointed out, the reagents employed are all commercially available products, which are directly used without further purification. In addition, the “%” mentioned refers to “wt %,” and the “parts” mentioned refers to “parts by weight.”

Testing Method

According to the particular method listed below, various photocurable adhesive tapes prepared in embodiments and comparative examples are tested for adhesiveness (including thrust adhesion force and adhesion area ratio).

Specifically, the release film on one side of the photocurable adhesive tape is peeled off first, and the exposed photocurable adhesive layer is respectively attached to the surface of the radiating rib as listed below. Next, the release film on the other side of the photocurable adhesive tape is peeled off, and the exposed photocurable adhesive layer is exposed at a height of 8 mm (UVATA 2.3 W/cm²) to ultraviolet light (UV machine's UVATA LED UV lamp UPL3-311) for 3 sec. Following that, the exposed photocurable adhesive layer is respectively laminated with the nickel-plated copper surface of the chip as listed below through a UV light tester (manufacturer EIT model UV POWER PACK II), and the chip is pressed under the weight of 4 gkf and kept for 20 sec to thoroughly wet the adhesive tape on the chip surface, so as to obtain an assembled sample. The assembly is left at room temperature for 24 h, and then testing of its adhesion strength is started. A low clamp of Instron 5565 available from Instron Company is used to clamp the assembly. An upward clamp at a moving speed of 30 mm/min is used to push the chip away from the surface of the adhesive tape/radiating rib, and the number of thrust is recorded as the thrust adhesion force (unit: Newton (N)). Adhesion area ratio (unit: %) refers to the ratio of the area of the residual photocurable adhesive layer on the surface of nickel-plated copper after the chip is pushed away from the surface of the adhesive tape/radiator to the area of the original photocurable adhesive layer on the surface of nickel-plated copper.

In the above tests, the following two radiating ribs are employed respectively to perform the tests:

B-HS radiating rib, which is a radiating rib made of blackened aluminum with a size of 50 mm×50 mm×8 mm; and

G-HS radiating rib, which is a silver-gray brushed aluminum radiating rib with a size of 55 mm×55 mm×8 mm.

Moreover, in the above tests, the following three chips are employed respectively in the tests:

DSM chip (NETLoGIC-NL9512EFVH-300-RA03), a medium silver-colored nickel-plated metal chip, which is a large size S chip with a size of 23 mm×23 mm×4 mm;

XSM chip (CANADA Hisilicon chip Hi-SD5873rfc-110), a small silver-colored nickel-plated metal chip, which is a small size S chip with a size of 13 mm×13 mm×3 mm; and

DSP chip (Taiwan Hisilicon Hi-SD5112RBC-200), a medium black plastic chip, which is a large size plastic chip with a size of 23 mm×23 mm×4 mm.

### Synthesis Example 1 (Copolymer 1; CSA960-1, Comprising Repeating Units Derived from Methyl Acrylate (MA), Repeating Units Derived from Butyl Acrylate (BA), Repeating Units Derived from Acrylic Acid (AA) and Repeating Units Derived from Glycidyl Methacrylate (GMA))

Appropriate amounts of methyl acrylate (MA), butyl acrylate (BA), acrylic acid (AA), glycidyl methacrylate (GMA) and an initiator were dissolved into ethyl acetate, stirred uniformly, and then transferred to a reactor. The reactor was sealed, and heated to 60-70° C. to allow reaction for 10 to 20 h. After the reaction vessel was cooled down, ethyl acetate was added to the reaction vessel for dilution, so as to obtain the copolymer 1 comprising repeating units derived from methyl acrylate (MA), repeating units derived from butyl acrylate (BA), repeating units derived from acrylic acid (AA) and repeating units derived from glycidyl methacrylate (GMA), where the weight ratio of methyl acrylate (MA), butyl acrylate (BA), acrylic acid (AA) and glycidyl methacrylate (GMA) was MA/BA/AA/GMA=68.75/24/6/0.25.

### Synthesis Example 2 (Copolymer 2; CSA960-2, Comprising Repeating Units Derived from Methyl Acrylate (MA), Repeating Units Derived from Butyl Acrylate (BA), Repeating Units Derived from Acrylic Acid (AA) and Repeating Units Derived from Glycidyl Methacrylate (GMA))

Appropriate amounts of methyl acrylate (MA), butyl acrylate (BA), acrylic acid (AA), glycidyl methacrylate (GMA) and an initiator were dissolved into ethyl acetate, stirred uniformly, and then transferred to a reactor. The reactor was sealed, and heated to 60-70° C. to allow reaction for 10 to 20 h. After reaction vessel was cooled, ethyl acetate was added to the reaction vessel for dilution, so as to obtain the copolymer 2 comprising repeating units derived from methyl acrylate (MA), repeating units derived from butyl acrylate (BA), repeating units derived from acrylic acid (AA), and repeating units derived from glycidyl methacrylate (GMA), where the weight ratio of methyl acrylate (MA), butyl acrylate (BA), acrylic acid (AA) and glycidyl methacrylate (GMA) was MA/BA/AA/GMA=70.5/22/6/0.5.

### Synthesis Example 3 (Copolymer 3; CSA930, Comprising Repeating Units Derived from Methyl Acrylate (MA), Repeating Units Derived from Butyl Acrylate (BA), Repeating Units Derived from Acrylic Acid (AA) and Repeating Units Derived from Glycidyl Methacrylate (GMA))

Appropriate amounts of methyl acrylate (MA), butyl acrylate (BA), acrylic acid (AA), glycidyl methacrylate (GMA) and an initiator were dissolved into ethyl acetate, stirred uniformly, and then transferred to a reactor. The reactor was sealed, and heated to 60-70° C. to allow reaction for 10 to 20 h. After the reaction vessel was cooled down, ethyl acetate was added to the reaction vessel for dilution, so as to obtain the copolymer 3 comprising repeating units derived from methyl acrylate (MA), repeating units derived from butyl acrylate (BA), repeating units derived from acrylic acid (AA) and repeating units derived from glycidyl methacrylate (GMA), where the weight ratio of methyl acrylate (MA), butyl acrylate (BA), acrylic acid (AA) and glycidyl methacrylate (GMA) was MA/BA/AA/GMA=68.5/27/3/0.5.

### Synthesis Example 4 (Copolymer 4; CSA910, Comprising Repeating Units Derived from Methyl Acrylate (MA), Repeating Units Derived from Butyl Acrylate (BA), Repeating Units Derived from Acrylic Acid (AA) and Repeating Units Derived from Glycidyl Methacrylate (GMA))

Appropriate amounts of methyl acrylate (MA), butyl acrylate (BA), acrylic acid (AA), glycidyl methacrylate (GMA) and an initiator were dissolved into ethyl acetate, stirred uniformly, and then transferred to a reactor. The reactor was sealed, and heated to 60-70° C. to allow reaction for 10 to 20 h. After the reaction vessel was cooled down, ethyl acetate was added to the reaction vessel for dilution, so as to obtain the copolymer 4 comprising repeating units derived from methyl acrylate (MA), repeating units derived from butyl acrylate (BA), repeating units derived from acrylic acid (AA) and repeating units derived from glycidyl methacrylate (GMA), where the weight ratio of methyl acrylate (MA), butyl acrylate (BA), acrylic acid (AA) and glycidyl methacrylate (GMA) was MA/BA/AA/GMA=48.5/50/1/0.5.

### Synthesis Example 5 (Copolymer 5, Comprising Repeating Units Derived from i-Octyl Acrylate (EHA), Repeating Units Derived from Glycidyl Methacrylate (GMA), Repeating Units Derived from Methyl Acrylate (MA), and Repeating Units Derived from Butyl Acrylate (BA))

Appropriate amounts of i-octyl acrylate (EHA), glycidyl methacrylate (GMA), methyl acrylate (MA), butyl acrylate (BA) and an initiator were dissolved into ethyl acetate, stirred uniformly, and then transferred to a reactor. The reactor was sealed, and heated to 60-70° C. to allow reaction for 10 to 20 h. After the reaction vessel was cooled down, ethyl acetate was added to the reaction vessel for dilution, so as to obtain the copolymer 5 comprising repeating units derived from acrylic acid (AA), repeating units derived from glycidyl methacrylate (GMA), repeating units derived from methyl acrylate (MA), and repeating units derived from butyl acrylate (BA). In addition, it can be obtained through calculation that in the copolymer 5, the copolymer 4 comprises, based on the total solid content thereof, 0.5 wt % of repeating units containing epoxy groups and contains no carboxylic groups.

### Synthesis Example 6 (Copolymer 6, Comprising Repeating Units Derived from Hydroxyethyl Acrylate (HEA), Repeating Units Derived from Glycidyl Methacrylate (GMA), Repeating Units Derived from Methyl Acrylate (MA), and Repeating Units Derived from Butyl Acrylate (BA))

Hydroxyethyl acrylate (HEA), glycidyl methacrylate (GMA), methyl acrylate (MA), butyl acrylate (BA) and an initiator were dissolved into ethyl acetate, stirred uniformly, and then transferred to a reactor. The reactor was sealed, and heated to 60-70° C. to allow reaction for 10 to 20 h. After the reaction vessel was cooled down, ethyl acetate was added to the reaction vessel for dilution, so as to obtain the copolymer 6 comprising repeating units derived from acrylic acid (AA), repeating units derived from glycidyl methacrylate (GMA), repeating units derived from methyl acrylate (MA), and repeating units derived from butyl acrylate (BA). In addition, it can be obtained through calculation that in the copolymer 6, the copolymer 6 comprises, based on the total solid content thereof, 0.5 wt % of repeating units containing epoxy groups and contains no carboxylic groups.

The names and manufacturers of various raw materials employed in the embodiments and comparative examples are listed in Table 1 below:

TABLE 1
Names and manufacturers of various raw materials employed
in embodiments and comparative examples

| Component | Trade Name | Manufacturer |
|---|---|---|
| Epoxy component | Epoxy resin YD128 | Baling |
| | | Petrochemical |
| | | Company, |
| | | China |
| Hydroxy-containing | Polyol VORANOL | Dow Chemical |
| compound | 2070 | Company, US |
| Photoinitiator | Triaryl sulfonium | IGM Resins |
| | hexafluorophosphate | Company, |
| | 1190 | China |
| Solvent | Ethyl acetate | Sinopharm |
| | | Group |
| | | Company |
| Surfactant | Silane surfactant | Dow Corning |
| | KH560, i.e., (γ-(2,3- | Company |
| | epoxypropoxy) | |
| | propyltrimethoxysilane) | |
| Acid catalyst | Cycat 4040 | Chlorite |
| | | Corporation, |
| | | US |
| Ethylene-vinyl | LEVAPREN 800 HV | Lanxess |
| acetate | | Company |
| copolymer (EVA) | | |
| Thermally | Boron nitride filler | Momentive |
| conductive filler | CF500 | China |
| | | Company |

### Embodiment 1

According to the formula shown in Table 2 below, the thermoplastic acrylic copolymer 1 obtained in the above Synthesis example 1 comprising both carboxylic groups and epoxy groups, an epoxy resin YD128, a polyol 2070, a photoinitiator 1190, a silane surfactant KH560, a thermally conductive filler and a solvent ethyl acetate were intensively mixed, so as to obtain a photocurable adhesive composition 1. The photocurable adhesive composition 1 was applied onto a first release layer (release paper) to form a photocurable adhesive layer, and then a second release layer (release paper) was covered onto the photocurable adhesive layer to obtain a photocurable adhesive tape 1.

### Embodiment 2 to 8 and Comparative Examples 1 to 4

Photocurable adhesive compositions 2 to 8 and comparative compositions 1 to 4 were obtained according to the formula shown in Table 2 below. Embodiments 2 to 8 and Comparative examples 1 to 4 were carried out in a way similar to how Embodiment 1 was obtained, except that the various components and content of Embodiments 2 to 8 and Comparative examples 1 to 4 were altered as shown in Table 2. In addition, photocurable adhesive tapes 2 to 8 and comparative adhesive tapes 1 to 4 were prepared, in a way similar to how Embodiment 1 was obtained, from the photocurable adhesive compositions 2 to 8 and comparative compositions 1 to 4.

TABLE 2
Components in Embodiments 1 to 8 and Comparative examples 1 to 4,
and content based on the total solid content of the composition (%)

| | Embodiment | Embodiment | Embodiment | Embodiment | Embodiment | Embodiment |
|---|---|---|---|---|---|---|
| Component | 1 | 2 | 3 | 4 | 5 | 6 |
| Copolymer 1 | 29.99 | 19.93 | 39.62 | 23.84 | 25.85 | |
| Copolymer 2 | | | | | | 29.99 |
| Copolymer 3 | | | | | | |
| Copolymer 4 | | | | | | |
| Copolymer 5 | | | | | | |
| Copolymer 6 | | | | | | |
| Ethylene-vinyl acetate | | | | | | |
| copolymer (EVA) | | | | | | |
| Epoxy resin YD128 | 29.99 | 39.86 | 20.22 | 35.76 | 33.61 | 29.99 |
| Polyol 2070 | 2.54 | 2.53 | 2.53 | 2.53 | 3.19 | 2.54 |
| Photoinitiator 1190 | 0.32 | 0.638 | 0.637 | 0.956 | 0.51 | 0.32 |
| Cycat 4040 | | | | | | |
| Silane surfactant KH560 | 0.44 | 0.44 | 0.44 | 0.44 | 0.44 | 0.44 |
| Boron nitride filler CF500 | 36.7 | 36.6 | 36.6 | 36.5 | 36.4 | 36.7 |
| Total (%) | 100 | 100 | 100 | 100 | 100 | 100 |
| | Embodiment | Embodiment | Comparative | Comparative | Comparative | Comparative |
| Component | 7 | 8 | example 1 | example 2 | example 3 | example 4 |
| Copolymer 1 | | | | | | |
| Copolymer 2 | | | | | | |
| Copolymer 3 | 29.99 | | | | | |
| Copolymer 4 | | 29.99 | | | | |
| Copolymer 5 | | | | 29.99 | | |
| Copolymer 6 | | | | | 29.99 | 29.33 |
| Ethylene-vinyl acetate | | | 29.99 | | | |
| copolymer (EVA) | | | | | | |
| Epoxy resin YD128 | 29.99 | 29.99 | 29.99 | 29.99 | 29.99 | 29.33 |
| Polyol 2070 | 2.54 | 2.54 | 2.54 | 2.54 | 2.54 | 2.54 |
| Photoinitiator 1190 | 0.32 | 0.32 | 0.32 | 0.32 | 0.32 | 0.32 |
| Cycat 4040 | | | | | | 1.35 |
| Silane surfactant KH560 | 0.44 | 0.44 | 0.44 | 0.44 | 0.44 | 0.44 |
| Boron nitride filler CF500 | 36.7 | 36.7 | 36.7 | 36.7 | 36.7 | 36.7 |
| Total (%) | 100 | 100 | 100 | 100 | 100 | 100 |

According to the method described in detail in the above testing method section, the photocurable adhesive tapes obtained in Embodiments 1 to 8 and Comparative examples 1 to 4 above were tested for the adhesiveness (including the thrust adhesion force and the adhesion area ratio), with particular results being shown in Table 3 below.

TABLE 3
Test results of adhesiveness (including the thrust adhesion force and the adhesion area
ratio) of photocurable adhesive tapes obtained in Embodiments 1 to 8 and Comparative
examples 1 to 4

| | XSM chip + B-HS | | DSM chip + G-HS | | DSP chip + G-HS | |
|---|---|---|---|---|---|---|
| | radiating rib | | radiating rib | | radiating rib | |
| | Thrust | Adhesion | Thrust | Adhesion | Thrust | Adhesion |
| | adhesion | area ratio | adhesion | area ratio | adhesion | area ratio |
| | force (N) | (%) | force (N) | (%) | force (N) | (%) |
| Embodiment 1 | 622 | 90 | 981 | 80 | 1070 | 40 |
| Embodiment 2 | 589 | 85 | 977 | 80 | 1031 | 40 |
| Embodiment 3 | 513 | 80 | 890 | 60 | 1015 | 40 |
| Embodiment 4 | 501 | 95 | 920 | 85 | 1001 | 55 |
| Embodiment 5 | 572 | 85 | 997 | 80 | 1300 | 50 |
| Embodiment 6 | 534 | 85 | 980 | 80 | 1227 | 50 |
| Embodiment 7 | 546 | 85 | 980 | 80 | 1108 | 50 |
| Embodiment 8 | 567 | 90 | 956 | 80 | 1210 | 55 |
| Comparative example 1 | 223 | 40 | 541 | 40 | 764 | 20 |
| Comparative example 2 | 470 | 70 | 740 | 30 | 66 | 30 |
| Comparative example 3 | 320 | 40 | 838 | 50 | N/A | N/A |
| Comparative example 4 | 308 | 40 | 820 | 50 | N/A | N/A |

It can be known from the results shown in Table 3 that, when thermoplastic acrylic copolymers 1 to 4 containing both carboxylic and epoxy groups are used as the thermoplastic polymer containing carboxylic and epoxy groups according to the present invention, good thrust adhesion force (N) and adhesion area ratio (0%) can be obtained for all different adhesion combinations of XSM chip+G-HS radiating rib, DSM chip+G-HS radiating rib, and DSP chip+G-HS radiating rib.

Results of Comparative example 1 confirm that when the thermoplastic acrylic copolymers (i.e., ethylene-vinyl acetate copolymer (EVA)) containing no carboxylic and epoxy groups are employed, the thrust adhesion force (N) and adhesion area ratio (%) properties are both significantly reduced.

Comparative example 2 employed the copolymer 5 prepared in Synthesis example 5 comprising repeating units derived from i-octyl acrylate (EHA), repeating units derived from glycidyl methacrylate (GMA), repeating units derived from methyl acrylate (MA), and repeating units derived from butyl acrylate (BA). The copolymer 5 comprised, based on the total solid content thereof, 0.5 wt % of repeating units containing epoxy groups and contained no carboxylic groups. Results of Comparative example 2 confirm that when the thermoplastic polymer contains no carboxylic groups, the thrust adhesion force (N) and adhesion area ratio (%) properties are both significantly reduced.

Comparative example 3 employed the copolymer 6 prepared in Synthesis example 6 comprising repeating units derived from hydroxyethyl acrylate (HEA), repeating units derived from glycidyl methacrylate (GMA), repeating units derived from methyl acrylate (MA), and repeating units derived from butyl acrylate (BA). The copolymer 6 comprised, based on the total solid content thereof, 0.5 wt % of repeating units containing epoxy groups and contained no carboxylic groups. Results of Comparative example 3 confirm that when the thermoplastic polymer contains no carboxylic groups, the thrust adhesion force (N) and adhesion area ratio (%) properties are both significantly reduced.

Comparative example 4 employed the copolymer 6 prepared in Synthesis example 6 comprising repeating units derived from hydroxyethyl acrylate (HEA), repeating units derived from glycidyl methacrylate (GMA), repeating units derived from methyl acrylate (MA), and repeating units derived from butyl acrylate (BA). The copolymer 6 comprised, based on the total solid content thereof, 0.5 wt % of repeating units containing epoxy groups and contained no carboxylic groups. In addition, an acid catalyst Cycat 4040 was further added into the adhesive composition according to Comparative example 4. Results of Comparative example 4 confirm that when the photocurable adhesive composition contains only epoxy groups but no carboxylic groups, the simple mixing and addition of an ionic acid (e.g., acid catalyst Cycat 4040) cannot achieve the aim of significantly improving the adhesion performance.

The embodiments described in the present invention are merely illustrative of the preferred embodiments of the present invention, and are not intended to limit the concept and scope of the present invention. Various variations and modifications made to the technical solutions of the present invention by those skilled in the art without departing from the design idea of the present invention shall all fall into the protection scope of the present invention. The technical content of the protection claimed by the invention has been fully recorded in the claims.

1. A photocurable adhesive composition, the photocurable adhesive composition comprising, based on the total content of solids thereof, the following:
10 to 40 wt % of a thermoplastic polymer containing carboxylic groups and epoxy groups;
20 to 50 wt % of an epoxy component;
1 to 10 wt % of a hydroxy-containing compound; and
0.1 to 5 wt % of a photoinitiator.

2. The photocurable adhesive composition according to claim 1, wherein the thermoplastic polymer comprises, based on the total solid content thereof, 0.01 to 10 wt % of repeating units containing carboxylic groups, or 0.01 to 5 wt % of repeating units containing epoxy groups.

3. The photocurable adhesive composition according to claim 1, wherein the thermoplastic polymer is a thermoplastic acrylic polymer, or a copolymer comprising repeating units derived from acrylic acid and repeating units derived from glycidyl (meth)acrylate.

4. The photocurable adhesive composition according to claim 1, wherein the epoxy component comprises one or a plurality of epoxy resins and/or epoxy monomers, and wherein the weight average molecular weight of the epoxy component is in a range from 100 to 5,000.

5. The photocurable adhesive composition according to claim 1, wherein the epoxy equivalent weight of the epoxy component is in a range from 80 g/eq to 1,000 g/eq.

6. The photocurable adhesive composition according to claim 1, wherein the hydroxy-containing compound is a polyol, or has a hydroxyl functionality of at least 1.

7. The photocurable adhesive composition according to claim 1, wherein the photocurable adhesive composition further comprises a thermally conductive filler having a thermal conductivity of 100 W/m·k or more, and wherein the thermally conductive filler is one or a plurality of materials selected from the group consisting of ceramic, metal oxide, metal nitride, metal hydroxide, BN, SiC, AlN, Al₂O₃, and Si₃N₄.

8. The photocurable adhesive composition according to claim 1, wherein the photocurable adhesive composition further comprises a surfactant.

9. The photocurable adhesive composition according to claim 8, wherein the surfactant is a silane surfactant.

10. A photocurable adhesive tape, the photocurable adhesive tape comprising the following:
a first release layer;
a photocurable adhesive layer; and
a second release layer,
wherein the photocurable adhesive layer is provided between the first release layer and the second release layer and comprises the photocurable adhesive composition according to claim 1.

11. The photocurable adhesive composition according to claim 1, wherein the weight average molecular weight of the thermoplastic polymer is in a range from 400,000 to 1,200,000.

12. The photocurable adhesive composition according to claim 1, wherein the photoinitiator is one or a plurality of photoinitiators selected from the group consisting of photoinitiators containing α-aminoketo groups, photoinitiators containing benzylketal groups, photoinitiators containing benzophenone groups, aryl iodonium salt photoinitiators, aryl sulfonium salt photoinitiators, alkyl sulfonium salt photoinitiators, iron aromatic salt photoinitiators, and sulfonylureaoxy free radical ketone photoinitiators.

13. The photocurable adhesive composition according to claim 1, wherein the photocurable adhesive composition further comprises a thermally conductive filler.

14. The photocurable adhesive composition according to claim 13, wherein the photocurable adhesive composition comprises, based on the total solid content thereof, 20 to 60 wt % of the thermally conductive filler.

15. The photocurable adhesive composition according to claim 8, wherein the photocurable adhesive composition comprises, based on the total solid content thereof, less than or equal to 5 wt % of the surfactant.
